(19) United States
(12) Patent Application Publication
(10) Pub. No.: US 2016/0323427 A1
(43) Pub. Date: Nov. 3, 2016

(54) A DUAL-MACHINE HOT STANDBY DISASTER TOLERANCE SYSTEM AND METHOD FOR NETWORK SERVICES IN VIRTUALILZED ENVIRONMENT

(71) Applicant: SHANGHAI JIAO TONG UNIVERSITY, Shanghai (CN)

(72) Inventors: Haibing Guan, Shanghai (CN); Ruhui Ma, Shanghai (CN); Jian Li, Shanghai (CN); Zhengwei Qi, Shanghai (CN); Zhengyu Qian, Shanghai (CN)

(21) Appl. No.: 14/412,125

(22) PCT Filed: Jul. 28, 2014
(86) PCT No.: PCT/CN2014/083113

§ 371 Date: Dec. 30, 2014

(30) Foreign Application Priority Data
Jan. 22, 2014 (CN) 201410029760.5

(51) Int. Cl. H04L 29/14; H04L 12/26; G06F 9/455; H04L 29/08

(52) U.S. Cl. CPC H04L 69/40; H04L 67/1002; H04L 43/10; G06F 9/45558; G06F 2009/45595

(57) ABSTRACT

The present invention provides a dual-machine hot standby disaster tolerance system for network service in virtualized environment. The system comprises a main server and a standby server, and the main server and the standby server are connected via network; a main VM runs on the main server; a standby VM runs on the standby server; the standby VM is in the alternative state of the application layer semantics of the main VM; the alternative state of the application layer semantics means that the standby VM can serve instead of the main server in view of the application layer semantics, and generate the correct output for any client request. The outputs of the main VM and standby VM are compared according to the alternative rule in order to determine whether a backup is needed, therefore efficiently reducing the backup frequency, and improving the system performance on the basis of ensuring rapid recovery; the present invention greatly reduces the system overhead and increases the system throughput.

### FIELD OF THE INVENTION

The present invention relates to highly reliable disaster tolerance technology in virtualized environment, and more particularly to a dual-machine hot standby disaster tolerance system and a method for network service in virtualized environment.

### DESCRIPTION OF THE PRIOR ART

At present, the networking service is the main form for cloud computing and data centers to provide services. However, due to the influence of power failures, hardware failures, disasters or human factors (collectively referred to as faults), sometimes these network applications may stop providing services, and lose data, which not only affects the users but also leads to economic loss. Therefore, how to improve disaster tolerance of network servers and rapidly recover external services after faults has become a focal research for many scholars and companies.

Some of the prior research results and products are achieved in virtualized environment.

With the rapid development and wide application of computer technology, especially the network technology, people have an urgent demand for software portability, particularly porting software in the network; software compatibility and portability are becoming more and more important. However, a number of different, incompatible operating systems and instruction set architectures (referred to as ISA) are generated during the development of computer technology, which causes the software portability to be limited to similar platforms. Computers based on a variety of ISAs and OSs may be included in a large network, which results in an increasingly sharp contradiction between the requirements of software portability and the current situation. The emergence of virtual machine (referred to as VM) technology eliminates these restrictions on software operating platforms, and it's possible to provide a higher degree of compatibility and portability. VM technology shields the platform differences by adding a layer of software to hardware execution platforms, or in other words, simulates another or multiple platforms on one platform.

At present, disaster tolerance solutions based on VM technology can be divided into the Checkpointing and Lockstepping techniques.

Checkpointing technique forms the main/standby server mode by utilizing two physical devices so as to perform backup for the same application/VM, and regularly backups the states of VMs on the main server to the standby server by means of VM migration technology, thereby realizing the disaster recovery. VMs on the standby server are in a non-operational state, and are capable of recovering rapidly to the previous state of the main server after faults of the main server, and retaining all the previous network connections, so that clients are not aware of the faults and recovery occurred on the server side. However, in order to ensure consistency between the states of VMs, frequent backups periodically (once every 20-40 ms) is necessary, which causes the throughput of the main server to be significantly reduced and CPU overhead to be too large. Meanwhile Checkpointing technique keeps all data packets sent to the client by the server in a buffer, and only when the backup completed, the data packets may be released, which increases network latency.

Lockstepping technique ensures the status of the main server is in conformity with that of the standby server by utilizing dual-machine operating in parallel, so that clients can be directly connected to the standby server after faults of the main server, helping rapid faults recovery. But Lockstepping technique can only be applied to the case of assigning a single processor to VM, which leads to poor performance scalability for multi-processor VMs, such as the performance for VMs with more than two processors is reduced to 1/7 for single-processor VM. In addition, for certain instructions, VMs on the master and standby servers can directly run in parallel, however, for the uncertain instructions, it is necessary to implement instruction-level synchronization among VMs on the master and standby servers, which increases system overhead.

### SUMMARY OF THE INVENTION

In view of the above disadvantages in the prior art, the present invention provides a dual-machine hot standby disaster tolerance system. In this solution, the main VM and standby VM run in parallel, generating the respective output results according to the request packets sent by the client; comparing the output results of the main VM and the standby VM, if not consistent, backup is needed, which not only ensures the rapid recovery after faults, but also reduces the system overhead efficiently.

The present invention provides a dual-machine hot standby disaster tolerance system, which is used for network services in virtualized environment. The system comprises a main server and a standby server, the main server and the standby server are connected via network, characterized in that: a main VM runs on the main server, a standby VM runs on the standby server, the standby VM is in an alternative state of the application layer semantics of the main VM, “the alternative state of the application layer semantics” means that the standby VM can serve instead of the main VM in view of the application layer semantics, and generate the correct output for any client request.

Further, the main server sends the client request to the main VM and standby VM respectively; the main VM and the standby VM run in parallel and generate the respective response packets.

Further, the dual-machine hot standby disaster tolerance system also comprises a main backup manager running on the main VM, and a standby backup manager running on the standby VM, the standby backup manager is used for sending the response packets generated by the standby VM to the main backup manager, the main backup manager is used for determining whether the response packets of the main VM and the standby VM are consistent. If yes, the standby VM is in the alternative state of the main VM; if no, the standby VM is not in the alternative state of the main VM.

Further, if the standby VM is not in the alternative state of the main VM, the main backup manager backups the current state of the main VM to the standby VM.

Further, the backup is non-periodic backup.

Further, the backup to the standby VM is incremental backup.

The system uses the way of incremental backup so as to reduce the overhead of state backup. Unlike the existing Checkpointing technique, the invention uses dual-machine running in parallel, therefore between two backups, the state of the standby VM will change, which leads to the fact that it is not enough to backup state increment of the main VM only. In order to reduce the contents transmitted during a backup, the invention trades space for time. When the connection between the main VM and the standby VM is established for the first time, the state of the main VM is completely transmitted to the standby VM and to a temporary buffer of the standby server at the same time. Only the changed contents since the last backup are transmitted every time when the main VM state is backed-up. First updating these contents to the temporary buffer of the standby server, and then backup all the contents in the temporary buffer to the standby VM, which avoids the influence of the changed standby VM state on incremental backup between two backups.

Further, the standby backup manager detects heartbeat packets of the main VM, if the standby backup manager does not receive the heartbeat packets of the main VM; the client request packets directly reach the standby VM. After the standby VM generates response packets, the standby backup manager directly sends the response packets to the client.

The system introduces a heartbeat packet mechanism, which is used by the standby VM to monitor whether the main VM is still alive. If the standby VM does not receive heartbeat packets, the standby VM takes that a fault has occurred on the main VM, and then takes the fault recovery measure to replace the main VM, so as to continue providing services. In this case, the request packets sent by the client is directly sent to the standby VM; after the standby VM generates the response packets, the response packets are no longer sent to the main VM, but to the client directly. In this case, the client receives packets of which the source is changed from the main VM to the standby VM, and does not find there has been a rapid fault recovery at the server side.

Further, in terms of memory backup, the system enables a shadow page table mechanism provided by a VM monitor, so as to get pages which have been modified since the last state backup. The rationale is to change all the pages of VMs to write-protected, in this case, once one page is written, an exception will be triggered, entering the exception handler.

The present invention also provides a dual-machine hot standby disaster tolerance method of the dual-machine hot standby disaster tolerance system, characterized by including the following steps:

(1) the main server sends request packets sent by a client to the main VM and the standby VM respectively by means of flow control;

(2) the main VM and standby VM run in parallel according to the client request, and generate respective response packet;

(3) the standby backup manager sends the response packets generated by the standby VM to the main backup manager;

(4) the main backup manager is used for determining whether the response packets of the main VM and the response packets of the standby VM are consistent. If yes, the standby VM is in the alternative state of the application layer semantics of the main VM, the main backup manager sends the response packets of the main VM to the client; if no, the standby VM is not in the alternative state of the main backup manager the main VM, the main backup manager backups the current state of the main VM to the standby VM.

Compared with the prior art, the dual-machine hot standby disaster tolerance system and method provided by the invention include the following beneficial technical results:

(1) The achievement of the system solves the technical problems in the case of the main server and the standby server dual-machine running in parallel, such as, the consistency of the storage access, the consistency of the network protocols, and the consistency of CPU instructions in multi core state, etc.

(2) Based on the alternative rule, in this solution the backup of the main server is non-periodic, the backup interval is more than one second, the frequency reduces more than two orders of magnitude with respect to the prior art, which reduces the system overhead greatly, and basically eliminates the performance interference of VM state backup with the main server.

(3) Compared with the existing solutions, the main server in the present invention may deliver the output results without waiting until the backup is completed, which increases the system throughput.

(4) The invention can provide rapid disaster recovery, the disaster recovery time is less than that in the prior art for network service and database service.

### BRIEF DESCRIPTION OF THE DRAWINGS

FIG. 1 is a flow diagram of the existing Checkpointing technique;

FIG. 2 is a flow diagram of the existing Lockstepping technique;

FIG. 3 is a flow diagram of dual-machine hot standby disaster tolerance system of an embodiment of the present invention;

FIG. 4 is a flow diagram of incremental backup process of dual-machine hot standby disaster tolerance system in an embodiment of the present invention.

### DETAILED DESCRIPTION OF THE PREFERRED EMBODIMENTS

Below in conjunction with the accompanying drawings and specific embodiments, the ideas, structures and technical results of the present invention will be further described so as to fully understand the objective, characteristics and effects of the present invention.

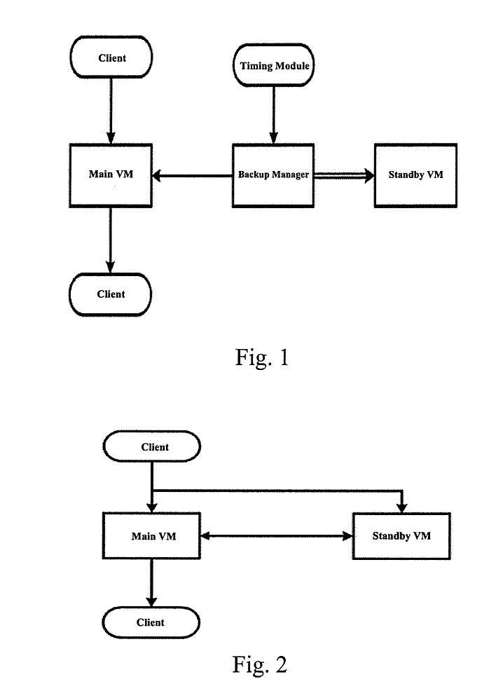

FIG. 1 is a flow diagram of the existing Checkpointing technique. The main VM processes client requests and generates responses; the standby VM is in the non-operational state. A timing module in the main server generates periodic events. After receiving the event, the backup manager obtains the main VM state, and backups the changed state since the last backup to the standby server.

FIG. 2 is a flow diagram of the existing Lockstepping technique. The main VM and the standby VM execute the request from a client in parallel; the main VM sends the response back to the client. If instructions are uncertain (such as memory access, clock interrupt), it is necessary to implement instruction-level synchronization among VMs, so as to avoid differences between the states of both sides.

The present invention provides a dual-machine hot standby disaster tolerance system, which is used for network service in virtualized environment. The system comprises a main server and a standby server, the main server and standby server are connected via network, characterized in that: a main VM runs on the main server, a standby VM runs on the standby server, the standby VM is in an alternative state of the application layer semantics of the main VM, “the alternative state of the application layer semantics” means that the standby server can serve instead of the main server in view of the application layer semantics, and generate the correct output for any client request.

The request packets from a client first reach the peripheral switch; the switch determines forwarding port by destination MAC address. When the main VM provides services, the corresponding port of the VM MAC address learned by the switch is the port of the network interface card of the main server, therefore the request packets are sent to the main server.

The main server sends the client request to the main VM and the standby VM respectively; the main VM and the standby VM run in parallel and generate the respective response packets.

The dual-machine hot standby disaster tolerance system also comprises a main backup manager running on the main VM, and a standby backup manager running on the standby VM, the standby backup manager is used for sending the response packets generated by the standby VM to the main backup manager which is used for determining whether the response packets of the main VM and the standby VM are consistent. If yes, the standby VM is in an alternative state of the main VM, the main backup manager sends the response packets to the client; if no, the standby VM is not in the alternative state of the main VM.

If the standby VM is not in the alternative state of the main VM, the main backup manager backups the current state of the main VM to the standby VM.

The backup is non-periodic backup.

The backup to the standby VM is incremental backup.

The system uses the way of incremental backup so as to reduce the overhead of state backup. Unlike the existing Checkpointing technique, the invention uses dual-machine running in parallel, therefore between two backups, the state of the standby VM will change, which leads to the fact that it is not enough to only backup state increment of the main VM. In order to reduce the contents transmitted during a backup, the invention trades space for time. When the connection between the main VM and the standby VM is established for the first time, the state of the main VM is completely transmitted to the standby VM and to a temporary buffer of the standby server at the same time. Only the changed contents since the last backup are transmitted every time when the main VM state is backed-up. First updating these contents to the temporary buffer of the standby server, and then backup all the contents in the temporary buffer to the standby VM, which avoids the influence of the changed standby VM state on incremental backup between two backups.

The standby backup manager detects heartbeat packets of the main VM, if the standby backup manager does not receive the heartbeat packets of the main VM; the client request packets directly reach the standby VM. After the standby VM generates response packets, the standby backup manager directly sends the response packets to the client.

The system introduces a heartbeat packet mechanism, the standby VM uses the heartbeat packet mechanism to monitor whether the main VM is still alive. If the standby VM does not receive heartbeat packets, the standby VM considers that a fault has occurred on the main VM, and then takes the fault recovery measure to replace the main VM, so as to continue providing services. The standby server will send an ARP packet to the switch, the source MAC address of the ARP packet is the MAC address of the standby VM. This makes the switch learn a new mapping entry from the MAC address to the port. Then the packet sent by the client of which the destination MAC address is a VM, will be directly sent to the network interface card of the standby server. After the standby VM generates the response packets, the response packets are no longer sent to the main VM, but to the client directly. In this case, the client receives packets of which the source is changed from the main VM to the standby VM, and does not find there has been a rapid fault recovery at the server side.

In terms of memory backup, the system enables a shadow page table mechanism provided by a VM monitor, so as to get pages which have been modified since the last state backup. The rationale is to change all the pages of VMs to write-protected, in this case, once one page is written, an exception will be triggered, entering the exception handler. By means of the “shadow page table” mechanism, it is easy to know which pages have been modified since the last state backup.

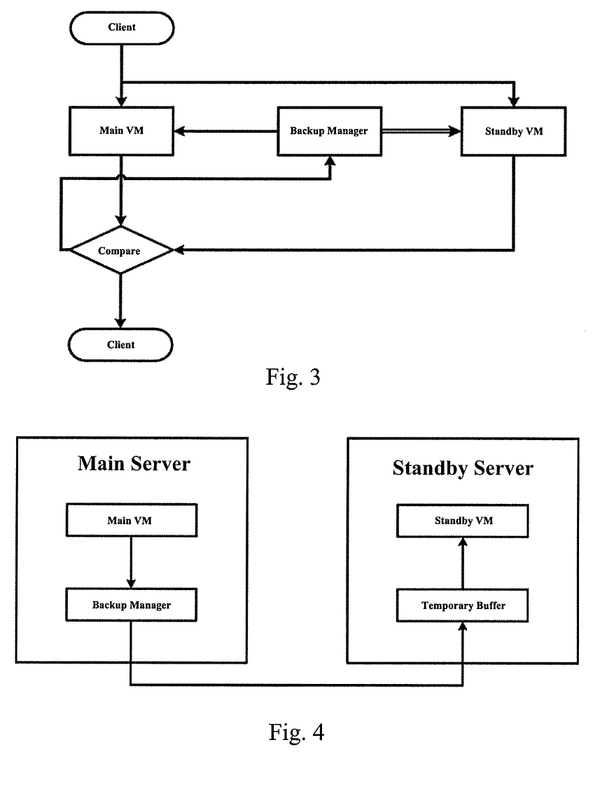

FIG. 3 is a flow diagram of dual-machine hot standby disaster tolerance system of the present embodiment, as described in the following procedure:

Step1. The main server sends the request packets sent by a client to the main VM and the standby VM respectively, the procedure is as follows: First, the request packets from the client is sent to the main server via the peripheral switch. After receiving the packets, the main server sends the packets to a software network bridge; intercepting and distributing network packets, and sending packets to the main VM and the standby VM are achieved by configuring the Traffic Control (referred to as TC) tool coming with Linux at the software network bridge.

A method for TC configuration is as follows:

#tc qdisc add dev vif1.0 root handle 1: prio

#tc filter add dev vif1.0 parent 1: protocol ip prio 10 u32 match u32 0 0 flowid 1:2 action mirred egress mirror dev eth0

#tc filter add dev vif1.0 parent 1: protocol am prio 11 u32 match u32 0 0 flowid 1:2 action mirred egress mirror dev eth0

Step2. The main VM and standby VM run in parallel according to the application layer semantics, and generate the respective outputs; the standby VM sends the output to the main server. Intercepting and forwarding the output of the standby VM is achieved by configuring TC, the specific method is as follows:

#tc qdisc add dev vif1.0 ingress

#tc filter add dev vif1.0parent ffff: protocol ip prio 10 u32 match u32 0 0 flowid 1:2 action mined egress redirect dev eth0

Step3. The manager of the main server compares the outputs generated by the main VM and the standby VM respectively, so as to determine whether the outputs meet the alternative rule. Specifically, two virtual interfaces in the form of queue are realized in the manager, and the outputs of the main VM and the standby VM are respectively redirected to one interface. The manager determines whether the standby VM is still in the alternative state of the main VM by comparing the two queues packet by packet. Redirecting the outputs is implemented by configuring TC. The specific method of configuring TC is as follows:

a) The redirection of the output packets of the main VM:

#tc qdisc add dev vif1.0 ingress

#tc filter add dev vif1.0 parent ffff: protocol ip prio 10 u32 match u32 0 0 flowid 1:2 action mined egress redirect dev ifb0

b) The redirection of the output packets of the standby VM:

#tc qdisc add dev eth0 ingress

#tc filter add dev eth0 parent ffff: protocol ip prio 10 u32 match u32 0 0 flowid 1:2 action mirred egress redirect dev ifb1

Step4. Sending the output of the main server back to the client as response packets;

Step5. If the standby VM is not in the alternative state of the main VM, backup the current state of the main VM to the standby VM. There is a respective backup daemon responsible for sending, receiving and updating the state of the VM in the manager on the main server or the standby server.

FIG. 4 is a flow diagram of incremental backup process of dual-machine hot standby disaster tolerance system of the present embodiment.

Step1. The backup manager on the main server obtains the changed section of the main VM state since the last backup.

Step2. The backup manager sends the changed section to the standby VM.

Step3. The standby VM updates the temporary buffer with the changed section.

Step4. Backup all the contents of the temporary buffer to the standby VM.

In terms of disk file backup, intercepting the disk write operation of the main VM and the standby VM is achieved by modifying the backend drivers of the disk devices. Between the two backups, the data written to the disk of the main VM and the standby VM is temporarily saved in the respective temporary buffer. The contents in the temporary buffer of the main VM are replaced by the contents in the temporary buffer of the standby VM, and then these contents are written to disk respectively when backup.

In terms of device backup, because the device states relates to the front end and back end models of the VM monitor, it is difficult to obtain the states; therefore, choosing the states before the device drivers of the main VM and the standby VM is discarded. After the backup is completed, the connection is reestablished to make the device states consistent.

The dual-machine hot standby disaster tolerance system and method provided by the invention solves the technical problems in the case of the main server and the standby server dual-machine running in parallel, such as, the consistency of the storage access, the consistency of the network protocols, and the consistency of CPU instructions in multi core state, etc. Based on the alternative rule, in this solution the backup of the main server is non-periodic, the backup interval is more than one second, the frequency reduces more than two orders of magnitude with respect to the prior art, which reduces the system overhead greatly, and basically eliminates the performance interference of VM state backup with the main server. The main server may deliver the output results without waiting until the backup is completed, which increases the system throughput. The invention can provide rapid disaster recovery, and the disaster recovery time is less than that in the prior art for network service and database service.

The foregoing described the preferred embodiments of the present invention. It should be understood that an ordinary one skilled in the art can make many modifications and variations according to the concept of the present invention without creative work. Therefore, any person skilled in the art can get any technical solution by logically analyzing, inferring and limited experiments, which should fall in the protection scope defined by the claims.

1. A dual-machine hot standby disaster tolerance system used for network services in virtualized environment, comprising a main server and a standby server, the main server and the standby server connected via network, characterized in that, a main VM runs on the main server, a standby VM runs on the standby server, the standby VM is in an alternative state of the application layer semantics of the main VM, the alternative state of the application layer semantics means that the standby VM can serve instead of the main VM in view of the application layer semantics, and generate the correct output for any client request.

2. The system according to claim 1, characterized in that, the main server sends the client request to the main VM and standby VM respectively; the main VM and the standby VM run in parallel and generate respective response packets.

3. The system according to claim 2, characterized in that, the system also comprises a main backup manager running on the main VM, and a standby backup manager running on the standby VM, the standby backup manager used for sending the response packets generated by the standby VM to the main backup manager, the main backup manager used for determining whether the response packets of the main VM and the standby VM are consistent, if yes, the standby VM is in the alternative state of the main VM; if no, the standby VM is not in the alternative state of the main VM.

4. The system according to claim 3, characterized in that, if the standby VM is not in the alternative state of the main VM, the main backup manager backups the current state of the main VM to the standby VM.

5. The system according to claim 4, characterized in that, the backup is non-periodic backup.

6. The system according to claim 4, characterized in that, the backup to the standby VM is incremental backup.

7. The system according to claim 3, characterized in that, the standby backup manager detects heartbeat packets of the main VM, if the standby backup manager does not receive the heartbeat packets of the main VM, after the standby VM generates response packets, the standby backup manager directly sends the response packets to the client.

8. The system according to claim 1, characterized in that, in terms of memory backup, the system enables a shadow page table mechanism provided by a VM monitor, so as to get pages which have been modified since last state backup.

9. A dual-machine hot standby disaster tolerance method of the dual-machine hot standby disaster tolerance system according to claim 1, characterized by including the following steps:
a) the main server sending request packets sent by a client to the main VM and the standby VM respectively by means of flow control;
b) the main VM and the standby VM running in parallel according to the client request, and generating respective response packets;
c) the standby backup manager sending the response packets generated by the standby VM to the main backup manager;
d) the main backup manager being used for determining whether the response packets of the main VM and the response packets of the standby VM are consistent, if yes, the standby VM is in the alternative state of the application layer semantics of the main VM, the main backup manager sends the response packets of the main VM to the client; if no, the standby VM is not in the alternative state of the application layer semantics of the main VM, the main backup manager backups the current state of the main VM to the standby VM.
